(19) United States
(12) Patent Application Publication
(10) Pub. No.: US 2018/0119039 A1
(43) Pub. Date: May 3, 2018

(54) SOURCE GAS PURIFICATION APPARATUS AND PURIFICATION METHOD

(71) Applicant: MITSUBISHI HEAVY INDUSTRIES, LTD., Tokyo (JP)

(72) Inventors: Yukio Tanaka, Tokyo (JP); Shigeru Nojima, Tokyo (JP); Masayuki Eda, Tokyo (JP); Tomoh Akiyama, Tokyo (JP)

(73) Assignee: MITSUBISHI HEAVY INDUSTRIES, LTD., Tokyo (JP)

(21) Appl. No.: 15/571,317

(22) PCT Filed: Jun. 15, 2016
(86) PCT No.: PCT/JP2016/067790

§ 371 Date: Nov. 2, 2017

(30) Foreign Application Priority Data
Jul. 3, 2015 (JP) 2015-134624

(51) Int. Cl. C10L 3/10; B01D 53/22; B01D 53/14; B01D 53/04

(52) U.S. Cl. CPC C10L 3/103; C10L 2290/541; B01D 53/1493; B01D 53/1462; B01D 53/1425; B01D 53/04; C10L 3/101; B01D 2252/20489; B01D 2257/304; B01D 2257/80; B01D 2259/40088; B01D 2256/24; B01D 2253/1124; B01D 2253/108; C10L 2290/542; B01D 53/229

(57) ABSTRACT

This source gas purification apparatus includes: a first H₂S removing device 2 which removes H₂S from a source gas that includes at least a hydrocarbon, H₂S, and a sulfur compound other than H₂S; a sulfur compound conversion device 3 which converts the sulfur compound other than H₂S into H₂S; and a second H₂S removing device 4 which removes the converted H₂S.

### TECHNICAL FIELD

The present invention relates to a source gas purification apparatus and a source gas purification method.

### BACKGROUND ART

Conventionally, in a case where untreated source gas includes impurities such as a sulfur compound and CO₂ (carbon dioxide), these impurities are removed. For example, untreated natural gas includes impurities such as CO₂, H₂S (hydrogen sulfide), COS (carbonyl sulfide), RSH (mercaptans), H₂O, and Hg (mercury), in addition to hydrocarbon (HC) such as methane.

As a conventional method for removing such impurities, for example, the following methods are employed.

(1) CO₂, H₂S, and a portion of COS are removed by chemical absorption using an amine compound.

(2) RSH and H₂O are removed by a molecular sieve.

(3) The molecular sieve is regenerated by desorbing RSH and H₂O by heating or decompression.

(4) The desorbed RSH is removed by physical absorption.

(5) COS that may not be removed in the step (1) is removed from the recovered NGL by using a Melox process or a molecular sieve.

(6) H₂S, COS, and RSH that are removed and recovered are recovered as sulfur obtained by solidifying an S portion via H₂S portion combustion and Claus reaction.

However, in these methods, at least two absorption steps such as chemical absorption and physical absorption are required, the replenishment of liquid becomes a heavy burden on the process, a running cost increases, and the entire system becomes complicated. The storage of the solidified sulfur has to be strictly controlled, and thus the administrative burden is heavy.

### CITATION LIST

### Patent Literature

[PTL 1] US Patent Publication No. 2014/0357926 A1

### SUMMARY OF INVENTION

### Technical Problem

As one of the technologies for solving the above problems, there is known a method relating to PTL 1 employing a guard bed for hydrolyzing COS to H₂S before source gas is chemically absorbed. However, in the method relating to PTL 1, an oxidized metallic material for decomposing COS was used in combination with an Hg adsorbent, and thus there was a concern in that the resolution capability of COS by the oxidized metallic material deteriorated in an early stage. In a state in which a large amount of H₂S was included in a source gas, there was a concern in which COS was not converted to H₂S.

PTL 1 discloses that gas-liquid separation by cooling was effective in the RSH treatment method. However, this method was effective for removing an organic sulfur compound from natural gas in which NGL (Natural gas condensate generated in natural gas production process) did not coexist, but, in a case where NGL that was not expected in PTL 1 coexists, an NGL component that is liquefied in the same temperature is mixed, and thus there is a difficulty in that an operation for further separating an organic sulfur compound from NGL is required in order to recover highly valuable NGL as a product.

The organic sulfur compound from NGL may be removed by an application to a Merox process, a molecular sieve, or the like. However, in a case where a device for removing such an organic sulfur compound is further added, processes become complicated, and thus there is a problem in that an equipment cost becomes expensive.

In view of the above circumstances, an object of the present invention is to provide a source gas purification apparatus and a source gas purification method that aim at reducing a burden such as cost and labor in a process and simplifying a system thereof.

### Solution to Problem

In order to accomplish the above objects, the present invention provides a source gas purification apparatus including: a first H₂S removing device which removes H₂S from source gas at least including hydrocarbon, H₂S, and a sulfur compound other than H₂S; a sulfur compound conversion device which converts the sulfur compound other than H₂S to H₂S; and a second H₂S removing device which removes the converted H₂S.

According to one embodiment of the source gas purification apparatus of the present invention, the sulfur compound other than H₂S may be COS and RSH.

According to another embodiment of the source gas purification apparatus of the present invention, the sulfur compound conversion device may be a COS.RSH conversion catalyst device.

According to another embodiment of the source gas purification apparatus of the present invention, the first H₂S removing device is a chemical absorption device.

According to another embodiment of the source gas purification apparatus of the present invention, the second H₂S removing device may be an adsorption and desorption device using an adsorbent. The adsorbent is preferably a molecular sieve or zinc oxide.

According to another embodiment, the source gas purification apparatus of the present invention may further include a H₂S combustion device; and a lime gypsum-type desulfurization apparatus which treats flue gas from the H₂S combustion device.

According to another embodiment of the source gas purification apparatus of the present invention, the first H₂S removing device may be a H₂S separation device including a H₂S separation membrane or a H₂S adsorbent, and the second H₂S removing device is a chemical absorption device.

According to another embodiment of the source gas purification apparatus of the present invention, the first H₂S removing device may be a H₂S separation device including a H₂S separation membrane or a H₂S adsorbent, and the second H₂S removing device may be an adsorption and desorption device.

According to another embodiment, the source gas purification apparatus of the present invention may further include a mercury removing device provided immediately before the sulfur compound conversion device.

According to another aspect, the present invention is a source gas purification method, and the source gas purification method includes: a first H₂S removal step of removing H₂S from source gas at least including hydrocarbon, H₂S, and a sulfur compound other than H₂S; a sulfur compound conversion step of converting the sulfur compound other than H₂S to H₂S; and a second H₂S removal step of removing the converted H₂S.

According to one embodiment of the source gas purification method of the present invention, the sulfur compound other than H₂S may be COS and RSH.

According to another embodiment of the source gas purification method of the present invention, the sulfur compound conversion step may be performed as a COS.RSH conversion step.

According to another embodiment of the source gas purification method of the present invention, the first H₂S removal step may be performed as a chemical absorption step.

According to another embodiment of the source gas purification method of the present invention, the second H₂S removal step is a removal step by an adsorption and desorption device using an adsorbent. The adsorbent is preferably a molecular sieve or zinc oxide.

According to another embodiment, the source gas purification method of the present invention may further include a H₂S combustion step; and a lime gypsum-type desulfurization step of treating flue gas from the H₂S combustion step.

According to another embodiment of the source gas purification method of the present invention, the first H₂S removal step may be performed as a separation step performed by using a H₂S separation device including a H₂S separation membrane or a H₂S adsorbent, and the second H₂S removal step may be performed as a chemical absorption step.

According to another embodiment of the source gas purification method of the present invention, the first H₂S removal step may be performed as a step performed by using a H₂S separation device including a H₂S separation membrane or a H₂S adsorbent, and the second H₂S removal step may be performed as an adsorption step performed by using an adsorption and desorption device.

According to another embodiment, the source gas purification method of the present invention may further include a mercury removal step provided immediately before the sulfur compound conversion step.

### Advantageous Effects of Invention

According to the present invention, a purification apparatus and a purification method thereof in which reduction of a burden such as cost and labor in a process is attempted, and simplification of the system is attempted, with respect to source gas at least including hydrocarbon, H₂S, and a sulfur compound other than H₂S.

### BRIEF DESCRIPTION OF DRAWINGS

FIG. 1 is a conceptual diagram illustrating a first embodiment of a source gas purification apparatus according to the present invention.

FIG. 2 is a conceptual diagram illustrating a second embodiment of the source gas purification apparatus according to the present invention.

FIG. 3 is a conceptual diagram illustrating a third embodiment of the source gas purification apparatus according to the present invention.

FIG. 4 is a conceptual diagram illustrating a fourth embodiment of the source gas purification apparatus according to the present invention.

### DESCRIPTION OF EMBODIMENTS

Hereinafter, embodiments of a source gas purification apparatus and a source gas purification method according to the present invention are described with reference to the accompanied drawings.

Source gas purification apparatus (first embodiment)

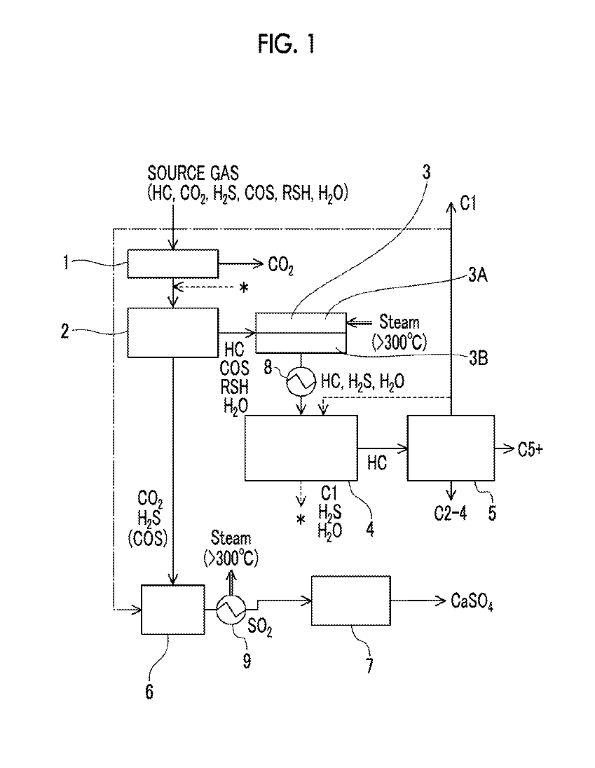

A first embodiment of a source gas purification apparatus according to the present invention is conceptually illustrated in FIG. 1.

The source gas purification apparatus according to the present embodiment includes a CO₂ separation device 1, a chemical absorption device 2, a sulfur compound conversion catalyst device 3, and an adsorption and desorption device 4, as main components.

According to the present embodiment, natural gas including CO₂, H₂S, a sulfur compound other than H₂S (mainly COS or RSH), and H₂O, as impurities is used as source gas of a treatment target, in addition to hydrocarbon such as methane.

The source gas that is a treatment target of the present invention is not limited to natural gas, and examples thereof include coal gasification gas, synthesized gas, coke oven gas, petroleum gas (such as associated gas accompanied by crude oil production). However, the present invention is not limited thereto, and gas including acid gas such as H₂S becomes an application target. That is, targets of the present embodiment and another embodiment of the present invention are not limited to natural gas.

The CO₂ separation device 1 is provided as a form of a CO₂ removing device. The CO₂ separation device 1 is a device that removes CO₂ and other gas components by using a difference between mobility of CO₂ and the other gas components in the film. As the CO₂ separation device 1, a CO₂ separation membrane is mainly used, and a well-known device including a polymer material such as cellulose, polysulfone, and polyimide and inorganic materials such as zeolite and carbon can be employed.

The chemical absorption device 2 is provided as a form of a first H₂S removing device. The chemical absorption device 2 removes residual CO₂ that is not completely removed by the CO₂ separation device 1, in addition to H₂S removal.

The chemical adsorption device 2 absorbs and removes residual CO₂ and H₂S by bringing an amine absorbent including an amine compound and source gas into contact with each other. After this absorption and removal, the amine absorbent is heated, so as to dissipate CO₂ and H₂S, and regenerate the amine absorbent.

Amine is a compound having weak basicity, and has a feature of adsorbing acidic substances such as CO₂ and H₂S and dissipating the acidic substances by heating. According to this feature, amine can be used as an absorbent of acid gas. As the amine absorbent, an absorbent based on N-methyl diethanolamine (MDEA) can be used.

The source gas from which CO₂ and H₂S are removed is sent to the sulfur compound conversion catalyst device 3. In addition to hydrocarbon such as methane, COS, RSH, and H₂O are included in the source gas from which CO₂ and H₂S are removed.

The sulfur compound conversion catalyst device 3 is provided as a form of the sulfur compound conversion device. The sulfur compound conversion catalyst device 3 according to the present embodiment is a COS.RSH conversion catalyst device including a front flow COS conversion catalyst device 3A and a back flow RSH conversion catalyst device 3B. The COS conversion catalyst device 3A converts COS to H₂S, and the RSH conversion catalyst device 3B converts RSH to H₂S.

Examples of a COS conversion catalyst used in the COS conversion catalyst device 3A include a catalyst including a carrier of Al₂O₃ and/or TiO₂ and an active ingredient of at least one kind of metal selected from the group consisting of calcium, magnesium, strontium, zinc, iron, copper, manganese, chromium, barium, nickel, ruthenium, cobalt, and molybdenum as a main component.

Examples of the RSH conversion catalyst used in the RSH conversion catalyst device 3B include at least one solid acid catalyst selected from silica-alumina and zeolite.

It is preferable that the COS conversion catalyst device 3A and the RSH conversion catalyst device 3B are consecutively arranged such that one of COS and RSH that has a smaller abundance ratio primarily becomes a treatment target. Possibly, this is because, in a case where the amount of H₂S to be produced increases, the amount of existing H₂S increases in the production system, and thus the reaction hardly progresses in the direction of producing H₂S on chemical equilibrium. In a case where the one having a smaller abundance ratio is first processed, the subsequent conversion target can be easily converted in a state in which an amount of H₂S is smaller.

In the general natural gas, the abundance ratio of RSH is greater, it is preferable that the COS conversion catalyst device 3A is primarily arranged, and the conversion of COS is first performed.

The COS conversion catalyst device 3A and the RSH conversion catalyst device 3B may simultaneously convert both COS and RSH by using a catalyst such as C—Mo/alumina, which is a catalyst integrated in the same reaction vessel and causing an inorganic oxide carrier to support at least one kind of metal belonging to Group V, Group VI and Group VII.

Any one of the COS conversion catalyst device 3A and the RSH conversion catalyst device 3B can be caused to be driven, according to the properties of source gas of treatment handling. Otherwise, any one of the COS conversion catalyst device 3A and the RSH conversion catalyst device 3B can be provided.

The adsorption and desorption device 4 is provided as a form of the second H₂S removing device. A material forming the adsorption and desorption device 4 may be an adsorbent such as zinc oxide or a molecular sieve in which a well-known material such as artificial zeolite is employed. The adsorption and desorption device 4 adsorbs and removes H₂S and H₂O from the sulfur compound conversion catalyst device 3. The adsorption and desorption device 4 performs regeneration by desorbing H₂S and H₂O by heating and decompression.

As illustrated in FIG. 1, the source gas purification apparatus according to the present embodiment includes an NGL recovery device 5, a H₂S combustion device 6, and a lime gypsum-type desulfurization apparatus 7, as other components.

The NGL recovery device 5 is a device that separates hydrocarbon obtained by causing the adsorption and desorption device 4 to remove H₂S and H₂O into C1 hydrocarbon (methane), C2-4 hydrocarbon (hydrocarbon having 2 to 4 carbon atoms), and C5+ (hydrocarbon having 5 or more carbon atoms). The NGL recovery device 5 separates hydrocarbon by a well-known method such as a cryogenic separation process using a turboexpander.

The H₂S combustion device 6 is a device that performs combustion treatment on H₂S and COS can be configured with a well-known combustion device such as a combustion burner.

The lime gypsum-type desulfurization apparatus 7 is an apparatus of recovering SO₂ (sulfurous acid gas) produced by combusting H₂S and COS as gypsum (CaSO₄.2H₂O). A well-known desulfurization apparatus can be employed as the lime gypsum-type desulfurization apparatus 7, the apparatus 7 generally suspends limestone (CaCO₃) in water so as to form a limestone slurry, brings this slurry into contact with flue gas in an absorption tower, absorbs and removes SO₂ in the flue gas, and forms gypsum by oxygen in the flue gas and oxygen in the air introduced into the absorption tower.

### Source Gas Purification Method (First Embodiment)

Subsequently, an embodiment of the source gas purification method according to the present invention is described by describing a mechanism of actions of the source gas purification apparatus according to the present embodiment including a device configuration of FIG. 1.

First, according to the present embodiment, the source gas is introduced to the CO₂ separation device 1. The CO₂ separation device 1 separates and removes CO₂ included in the source gas from the other gas component by a separation membrane.

Subsequently, the source gas from which CO₂ is removed is introduced to the chemical absorption device 2. In the chemical absorption device 2, H₂S is removed by chemical absorption. Residual CO₂ that is not completely removed by the CO₂ separation device 1 can be removed in the chemical absorption device 2, in addition to the removal of H₂S. A portion of COS can also be absorbed and removed. In a case where CO₂ concentration in the source gas is low, only the chemical absorption device 2 is used for separation and removal of CO₂, and the CO₂ separation device 1 may be omitted.

The source gas from which CO₂ and H₂S are removed is sent to the sulfur compound conversion catalyst device 3. Sulfur compounds other than H₂S (described as COS and RSH in FIG. 1) and H₂O are included in the source gas from which CO₂ and H₂S are removed, in addition to hydrocarbon such as methane.

Vapor is introduced to each of the front flow COS conversion catalyst device 3A and the RSH conversion catalyst device 3B included in the sulfur compound conversion catalyst device 3, COS is converted to H₂S, by the above COS conversion catalyst device 3A, and RSH is converted to H₂S by the back flow RSH conversion catalyst device 3B. The temperature of the introduced vapor is preferably 100° C. to 700° C. and more preferably a temperature greater than 300° C.

Gas including hydrocarbon, H₂S, and H₂O which can be obtained by converting COS and RSH to H₂S by the sulfur compound conversion catalyst device 3 is introduced to the adsorption and desorption device 4 via a cooler 8. The adsorption and desorption device 4 adsorbs and removes H₂S and H₂O included in the gas.

The gas from which H₂S and H₂O are removed becomes highly pure hydrocarbon and is sent to the NGL recovery device 5.

The adsorption and desorption device 4 is regenerated by desorbing H₂S and H₂O by heating and decompression. The desorbed H₂S and H₂O is transported by C1 hydrocarbon (methane) supplied from the NGL recovery device 5, is confluent with the source gas from the CO₂ separation device 1 (illustrated as * in FIG. 1), and is introduced to the chemical absorption device 2.

The gas sent to the NGL recovery device 5 is separated into C1 hydrocarbon (methane), C2-4 hydrocarbon (hydrocarbon having 2 to 4 carbon atoms), and C5+ hydrocarbon (hydrocarbon having 5 carbon atoms).

Independently from the C1 hydrocarbon after NGL recovery that is recovered as deliverables, a portion thereof is sent to the H₂S combustion device 6 as auxiliary fuel.

C2-4 hydrocarbon and C5+ hydrocarbon are recovered as deliverables.

Meanwhile, the chemical absorption device 2 dissipates H₂S, COS, and CO₂ by performing a heating operation on an amine absorbent. H₂S, COS, and CO₂ are sent to the H₂S combustion device 6.

C1 hydrocarbon from the NGL recovery device 5 is also sent to the H₂S combustion device 6. C1 hydrocarbon, H₂S, and COS are combusted by the H₂S combustion device 6.

The flue gas obtained after combusting C1 hydrocarbon, H₂S, and COS is sent to the lime gypsum-type desulfurization apparatus 7 via a heat exchanger 9.

Heat obtained from the heat exchanger 9 can be used in the production of vapor in the temperature greater than 300° C. supplied to the sulfur compound conversion catalyst device 3.

The lime gypsum-type desulfurization apparatus 7 recovers SO₂ (sulfurous acid gas) obtained by combusting H₂S and COS, as gypsum (CaSO₄.2H₂O). The lime gypsum-type desulfurization apparatus 7 forms a limestone slurry by suspending limestone (CaCO₃) in water, brings this slurry into contact with flue gas by the absorption tower, absorbs and removes SO₂ in the flue gas, and forms gypsum by oxygen in the flue gas and oxygen in the air introduced to the absorption tower.

According to the source gas purification apparatus and source gas purification method according to this first embodiment, the absorption step called the chemical absorption step is completed in one step, so as to aim at reducing a burden such as cost and labor in a process. The system is also simple. The S component is recovered as gypsum (CaSO₄.2H₂O), and thus burden in terms of storage is small.

### Source Gas Purification Apparatus and Source Gas Purification Method (Second Embodiment)

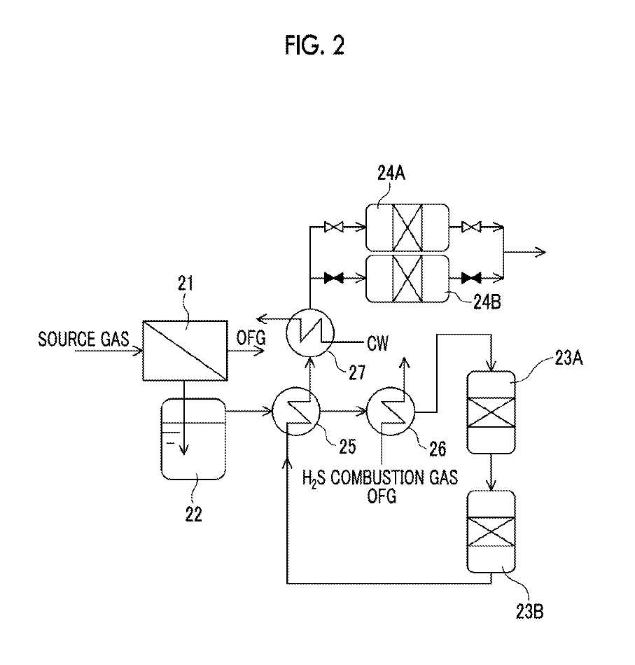

A second embodiment of the source gas purification apparatus according to the present invention is conceptually illustrated in FIG. 2.

In the second embodiment, the first embodiment is provided in a specific level. However, those illustrated in the second embodiment in FIG. 2 are visually different from the first embodiment in appearance, and thus is described as the second embodiment for easier description.

In the second embodiment, a CO₂ separation device 21 corresponds to the CO₂ separation device 1, a chemical absorption device 22 corresponds to the chemical absorption device 2, a COS conversion catalyst device 23A corresponds to the COS conversion catalyst device 3A, an RSH conversion catalyst device 23B corresponds to the RSH conversion catalyst device 3B, adsorption and desorption devices 24A and 24B correspond to the adsorption and desorption device 4, and the contents described as the first embodiment with respect to the component equipment are incorporated in the present embodiment.

In FIG. 2, the H₂S combustion device, the NGL recovery device, the lime gypsum-type desulfurization apparatus are not illustrated.

Subsequently, the present embodiment is described by describing a mechanism of actions of the component equipment according to this second embodiment. This description of the mechanism of actions is the description of the second embodiment of the source gas purification method according to the present invention.

First, as illustrated in FIG. 2, the source gas is introduced to the CO₂ separation device 21. The CO₂ separation device 21 separates and removes CO₂ included in the source gas from the other gas components by a separation membrane.

In a case where the source gas which is the target of the present invention is subjected to membrane separation, with respect to a CO₂ proportion in the source gas, gas in which a CO₂ proportion is reduced can be obtained in an outlet on a primary side of the film, and gas in which a CO₂ proportion is increased can be obtained in an outlet on a secondary side thereof.

In a case where a target CO₂ proportion in the outlet gas on the primary side of the film is not achieved, an absorption method is combined. That is, the chemical absorption device 22 takes this role. Meanwhile, since a portion of the flammable gas such as methane is also included in gas on the secondary side, heat recovery can be performed by burning off gas (OFG in FIG. 2) on the secondary side and using the off gas as a heat source. Otherwise, an operation of repressurizing the off gas, recycling the off gas to the primary side, and recovering the off gas as a product may be performed.

According to the present embodiment, off gas (OFG in FIG. 2) on the secondary side is combusted to perform heat recovery.

Subsequently, the source gas from which CO₂ is removed is introduced to the chemical absorption device 22. The chemical absorption device 22 removes H₂S by chemical absorption. The chemical absorption device 22 can also remove residual CO₂ that is not completely removed by the CO₂ separation device 1 in addition to the removal of H₂S. In addition, a portion of COS is absorbed and removed.

The chemical absorption device 22 dissipates H₂S, COS, and CO₂ by performing a heating operation on the amine absorbent. H₂S, COS, and CO₂ are sent to the H₂S combustion device.

In a case where a CO₂ concentration in the source gas is low, only the chemical absorption device 2 is used for separation and removal of CO₂, and the CO₂ separation device 1 may be omitted.

The source gas from which CO₂ and H₂S are removed is heated gas from the RSH conversion catalyst device 23B by a heat exchanger 25 and heated by H₂S combustion gas and combustion gas obtained by combusting off gas with a heat exchanger 26, such that the temperature thereof preferably becomes a temperature greater than 300° C.

The source gas from which CO₂ and H₂S are removed is sent to the COS conversion catalyst device 23A and subsequently sent to the RSH conversion catalyst device 23B. The source gas becomes a temperature greater than 300° C., COS is converted to H₂S by the front flow COS conversion catalyst device 23A, and RSH is converted to H₂S by the back flow RSH conversion catalyst device 23B.

The COS conversion catalyst device 23A and the RSH conversion catalyst device 23B are consecutively arranged such that one of COS and RSH that has a smaller abundance ratio primarily becomes a treatment target. This is because, in a case where the amount of H₂S to be produced increases, the amount of existing H₂S increases in the production system, and thus the reaction hardly progresses in the direction of producing H₂S on chemical equilibrium. In a case where the one having a smaller abundance ratio is first processed, the subsequent conversion target can be easily converted in a state in which an amount of H₂S is smaller.

According to the present embodiment, it is assumed that an abundance ratio of RSH is greater, the COS conversion catalyst device 23A is primarily arranged, and thus COS conversion is first performed.

Gas including hydrocarbon, H₂S, and H₂O which can be obtained by converting COS and RSH to H₂S is introduced to the adsorption and desorption devices 24A and 24B via a cooler 27. The cooler 27 cools the gas by cooling water. The adsorption and desorption devices 24A and 24B adsorb and remove H₂S and H₂O included in the gas.

The gas from which H₂S and H₂O are removed becomes highly pure hydrocarbon and is sent to an NGL recovery device (not illustrated).

The adsorption and desorption devices 24A and 24B are regenerated by desorbing H₂S and H₂O by heating or decompression. Desorbed H₂S and H₂O are transported by C1 hydrocarbon (methane) supplied from the NGL recovery device, is confluent with the source gas from the CO₂ separation device 21, and is introduced to the chemical absorption device 22.

In the illustrated state, an adsorption and desorption device 24B is closed, and H₂S and H₂O are adsorbed by an adsorption and desorption device 24A. A valve (not shown) is opened, the adsorption and desorption device 24B is heated and decompressed, so as to desorb H₂S and H₂O.

In this manner, the adsorption and desorption devices 24A and 24B alternatively repeat adsorption and desorption so as to perform a continuous operation of the entire device.

As described above, this second embodiment is an embodiment describing the first embodiment in a specific level. Accordingly, this second embodiment has the same effect as the first embodiment. In addition to this basic effect, in this second embodiment, it is understood that an effect of enhancing thermal efficiency of a system by combustion of the off gas is exhibited. In this second embodiment, it is understood that two absorption towers included in the adsorption and desorption device alternatively repeat adsorption and desorption, such that an effect of causing the entire device to be continuously driven is exhibited.

### Source Gas Purification Apparatus and Source Gas Purification Method (Third Embodiment)

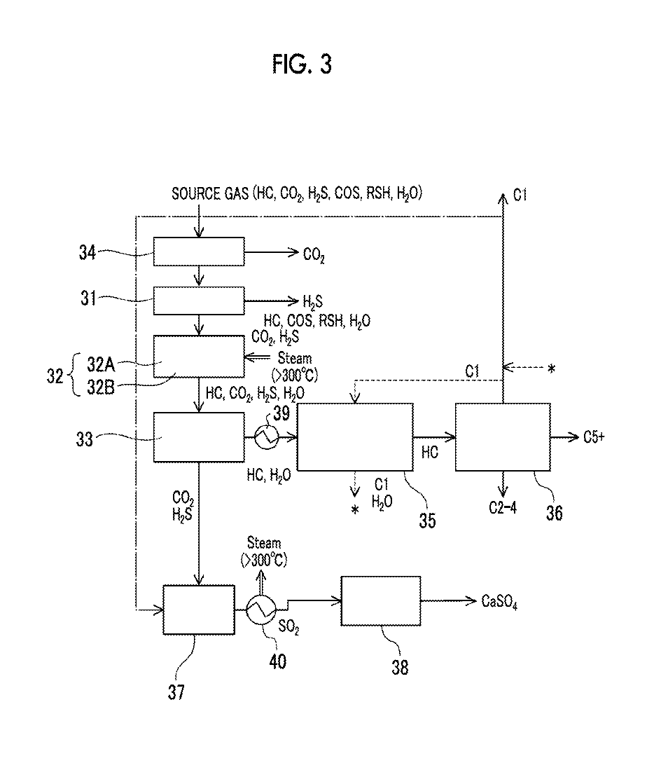

The third embodiment of the source gas purification apparatus according to the present invention is conceptually illustrated in FIG. 3.

In this third embodiment, a H₂S separation device 31 is employed as a first H₂S removing device, a sulfur compound conversion catalyst device 32 which is the same as the first embodiment is employed as a sulfur compound conversion device that converts a sulfur compound other than H₂S to H₂S, and a chemical absorption device 33 that is the same as the first embodiment is employed as a second H₂S removing device.

A CO₂ separation device 34, an adsorption and desorption device 35, an NGL recovery device 36, a H₂S combustion device 37, and a lime gypsum-type desulfurization apparatus 38 basically have the same configuration as the first embodiment.

The contents of the component equipment having the same names other than the H₂S separation device 31 are the same as those provided in the first embodiment, and thus are basically applied to the present embodiment.

The H₂S separation device 31 is a device that selectively removes H₂S from natural gas including CO₂, H₂S, a sulfur compound other than H₂S (mainly COS or RSH), and H₂O, in addition to hydrocarbon such as methane, as impurities by a H₂S separation membrane.

As the H₂S separation membrane, materials through which H₂S or carbon dioxide gas easily pass, and methane or the like hardly passes, which are disclosed in Japanese Unexamined Patent Application Publication No. H07-155787 can be used. As such a H₂S separation membrane, a membrane including silicon, polyimide, and cellulose acetate can be exemplified.

In addition to the membrane separation using such a H₂S separation membrane, a configuration in which H₂S adsorption is performed by a molecular sieve or zinc oxide is possible.

Subsequently, the present embodiment is described by describing a mechanism of actions of the component equipment according to this third embodiment. This description of the mechanism of actions is the description of the third embodiment of the source gas purification method according to the present invention.

First, in the present embodiment, the source gas is introduced to the CO₂ separation device 34. The CO₂ separation device 34 separates and removes CO₂ included in the source gas from other gas components by a separation membrane.

Subsequently, the source gas from which CO₂ is removed is introduced to the H₂S separation device 31. In the H₂S separation device 31, H₂S is removed by a H₂S separation membrane or an adsorbent. The removed H₂S is combusted by the H₂S combustion device 37. In addition to the removal of H₂S, the H₂S separation device 31 can remove residual CO₂ that is not completely removed by the CO₂ separation device 34.

The source gas from which CO₂ and H₂S are removed is sent to the sulfur compound conversion catalyst device 32. In addition to hydrocarbon such as methane, a sulfur compound other than H₂S (described as COS and RSH in FIG. 3), and H₂O are included in the source gas from which CO₂ and H₂S are removed.

Vapor preferably in a temperature of greater than 300° C. is introduced respectively to a COS conversion catalyst device 32A and a RSH conversion catalyst device 32B included in the sulfur compound conversion catalyst device 32, COS is converted to H₂S by the front flow COS conversion catalyst device 32A, and RSH is converted to H₂S by the back flow RSH conversion catalyst device 32B.

The sulfur compound conversion catalyst device 32 introduces gas including hydrocarbon, H₂S, CO₂ (byproduct), and H₂O which is obtained by converting COS and RSH to H₂S, to the chemical absorption device 33. The chemical absorption device 33 adsorbs and removes H₂S and CO₂ included in the gas.

The gas from which H₂S and CO₂ are removed includes hydrocarbon and H₂O, and is sent to the adsorption and desorption device 35 via a cooler 39.

H₂O is adsorbed and removed from the adsorption and desorption device 35.

The adsorption and desorption device 35 is regenerated by desorbing H₂O by heating and decompression. Desorbed H₂O is transported by C1 hydrocarbon (methane) supplied from the NGL recovery device 5 and is confluent with an outgoing line of C1 hydrocarbon (illustrated as * in the drawing).

Gas sent to the NGL recovery device 36 is separated into C1 hydrocarbon (methane), C2-4 hydrocarbon (hydrocarbon having 2 to 4 carbon atoms), and C5+ hydrocarbon (hydrocarbon having 5 or greater carbon atoms).

Independently from C1 hydrocarbon recovered as deliverables, a portion thereof is sent to the adsorption and desorption device 35 as described above, and another portion thereof is sent to the H₂S combustion device 37.

C2-4 hydrocarbon and C5+ hydrocarbon are recovered as deliverables.

Meanwhile, the chemical absorption device 33 dissipates H₂S and CO₂ by performing a heating operation on the amine absorbent. H₂S and CO₂ are sent to the H₂S combustion device 37.

C1 hydrocarbon is also sent to the H₂S combustion device 37 from the NGL recovery device 36 as described above. C1 hydrocarbon and H₂S are combusted by the H₂S combustion device 37.

The flue gas obtained by combusting C1 hydrocarbon and H₂S is sent to the lime gypsum-type desulfurization apparatus 38 via a heat exchanger 40.

Heat obtained by the heat exchanger 40 can be used in the production of the vapor in the temperature greater than 300° C. which is supplied to the sulfur compound conversion catalyst device 32.

The lime gypsum-type desulfurization apparatus 38 recovers SO₂ (sulfurous acid gas) obtained by combusting H₂S and COS as gypsum (CaSO₄.2H₂O). The lime gypsum-type desulfurization apparatus 38 forms limestone slurry by suspending limestone (CaCO₃) in water, brings this slurry into contact with flue gas by the absorption tower, absorbs and removes SO₂ in the flue gas, and forms gypsum by oxygen in the flue gas and oxygen in the air introduced to the absorption tower.

In addition to the effect that can be expected in the first embodiment, an effect in which a burden of the adsorption and desorption device 35 is reduced such that the size thereof is caused to be compact can be expected in this third embodiment.

In the third embodiment, the chemical absorption device 33 may not be provided. In this case, the entire gas including hydrocarbon, H₂S, and H₂O is sent from the sulfur compound conversion catalyst device 32 to the adsorption and desorption device 35, so as to adsorb H₂S and H₂O. Accordingly, highly pure hydrocarbon is obtained and sent to the NGL recovery device 36. H₂S and H₂O are desorbed from the adsorption and desorption device 35 by C1 hydrocarbon from the NGL recovery device 36 and sent to the H₂S separation device 31. Other treatments can be performed in the same manner as the above third embodiment.

### Source Gas Purification Apparatus and Source Gas Purification Method (Fourth Embodiment)

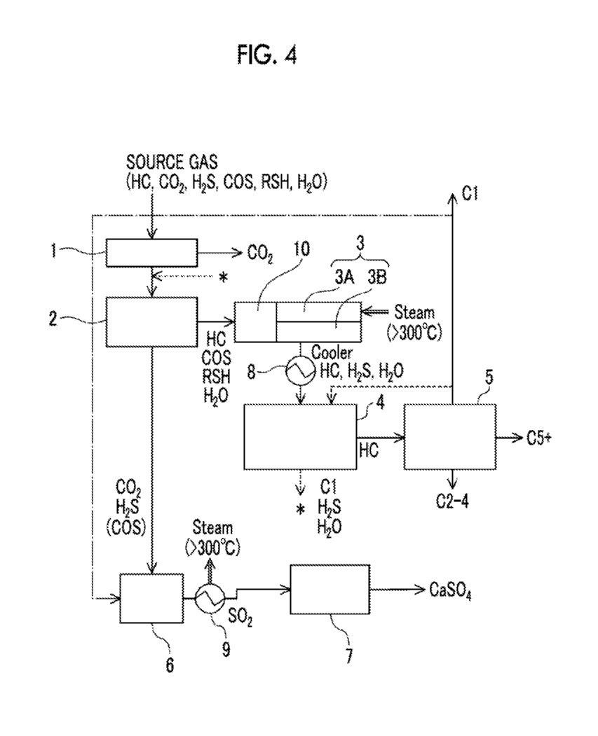

The source gas purification apparatus according to the present invention is provided in FIG. 4, and the fourth embodiment is conceptually provided.

This fourth embodiment is a form in which the mercury removing device 10 is provided immediately before the sulfur compound conversion catalyst device 3 according to the first embodiment.

According to the present embodiment, in addition to hydrocarbon such as methane, natural gas including CO₂, H₂S, a sulfur compound other than H₂S (mainly COS or RSH), H₂O, and Hg as impurities is provided as the source gas of the treatment target.

According to the present embodiment, the components indicated by the same reference numerals provided in FIG. 1 have substantially the same configurations as in FIG. 1, and substantially takes the same role.

The mechanism of actions of the present embodiment, that is, one embodiment of the source gas purification method according to the present invention, is substantially the same as those illustrated in FIG. 1. However, the present embodiment is different from the first embodiment in that a mercury removal step in which a mercury removing device 10 is operated is added.

The mercury removing device 10 is provided for the purpose of removing mercury (single substance of Hg, or organic mercury), which is a trace component.

As the mercury removing device 10 that can be employed, activated carbon may be used as a physical adsorbent, or a molecular sieve may be used. However, this method by physical adsorption tends to cause the device to have large capacity. Accordingly, it is preferable to include a mercury adsorbent (chemical adsorbent) as a guard reactor of the sulfur compound conversion catalyst device 3.

As the included mercury adsorbent, sulfide (such as CuS and/or MoS₃) is preferable. In this form of employing such a mercury adsorbent, due to the chemical adsorption, an adsorption amount is great, and thus space can be saved. In order to cause mercury to be fixed and adsorbed as sulfide, fixation can be performed regardless of the kinds of mercury. The heating temperature of the mercury adsorbent is near 100° C. to 300° C., and a heat source which is the same heat source that heats the sulfur compound conversion catalyst device 3 can be employed.

According to this fourth embodiment, in addition to the effect exhibited by the first embodiment, an effect of effectively removing mercury included in the source gas can be expected. An effect of preventing poisoning of the conversion catalyst used in the sulfur compound conversion catalyst device 3 existing on the back flow can be expected.

### REFERENCE SIGNS LIST

1, 34 CO₂ separation device
2, 33 Chemical absorption device
3, 32 Sulfur compound conversion catalyst device
4, 35 Adsorption and desorption device
5, 36 NGL recovery device
6, 37 H₂S combustion device
7, 38 Lime gypsum-type desulfurization apparatus
8, 39 Cooler
9, 40 Heat exchanger
10 Mercury removing device
31 H₂S separation device

1-18. (canceled)

19. A source gas purification device comprising:
a first H₂S removing device which removes H₂S from source gas at least including hydrocarbon, H₂S, and a sulfur compound other than H₂S;
a sulfur compound conversion device which converts the sulfur compound other than H₂S to H₂ S ; and
a second H₂S removing device which removes the converted H₂S.
wherein the sulfur compound conversion device is a COS.RSH conversion catalyst device including a COS conversion catalyst device and an RSH conversion catalyst device, and
wherein the COS conversion catalyst device and the RSH conversion catalyst device are consecutively arranged such that one of COS and RSH which has a smaller abundance ratio primarily becomes a treatment target.

20. The source gas purification device according to claim 19,
wherein the sulfur compound other than H₂S is COS and RSH.

21. The source gas purification device according to claim 19,
wherein the first H₂S removing device is a chemical absorption device.

22. The source gas purification device according to claim 19,
wherein the second H₂S removing device is an adsorption and desorption device using an adsorbent.

23. The source gas purification device according to claim 19, further comprising:
a H₂S combustion device; and
a lime gypsum-type desulfurization apparatus which treats flue gas from the H₂S combustion device.

24. The source gas purification device according to claim 19,
wherein the first H₂S removing device is a H₂S separation device including a H₂S separation membrane or a H₂S adsorbent, and
wherein the second H₂S removing device is a chemical absorption device.

25. The source gas purification device according to claim 19,
wherein the first H₂S removing device is a H₂S separation device including a H₂S separation membrane or a H₂S adsorbent, and
wherein the second H₂S removing device is an adsorption and desorption device.

26. The source gas purification device according to claim 19, further comprising:
a mercury removing device provided immediately before the sulfur compound conversion device.

27. A source gas purification method, comprising:
a first H₂S removal step of removing H₂S from source gas at least including hydrocarbon, H₂S, and a sulfur compound other than H₂S;
a sulfur compound conversion step of converting the sulfur compound other than H₂S to H₂ S ; and
a second H₂S removal step of removing the converted H₂S,
wherein the sulfur compound conversion step is a COS.RSH conversion step performing a COS conversion step and a RSH conversion step, and
wherein the COS conversion step and the RSH conversion step are consecutively performed such that one of COS and RSH which has a smaller abundance ratio primarily becomes a treatment target.

28. The source gas purification method according to claim 27,
wherein the sulfur compound other than H₂S is COS and RSH.

29. The source gas purification method according to claim 27,
wherein the first H₂S removal step is a step of absorbing and removing H₂S by a chemical absorption device.

30. The source gas purification method according to claim 27,
wherein the second H₂S removal step is a H₂S removal step by an adsorption and desorption device using an adsorbent.

31. The source gas purification method according to claim 27, further comprising:
a H₂S combustion step; and
a lime gypsum-type desulfurization step of treating flue gas from the H₂S combustion step.

32. The source gas purification method according to claim 27,
wherein the first H₂S removal step is a step performed by using a H₂S separation device including a H₂S separation membrane or a H₂S adsorbent, and
wherein the second H₂S removal step is an absorption step performed by a chemical absorption device.

33. The source gas purification method according to claim 27,
wherein the first H₂S removal step is a step performed by using a H₂S separation device including a H₂S separation membrane or a H₂S adsorbent, and
wherein the second H₂S removal step is an adsorption step performed by using an adsorption and desorption device.

34. The source gas purification method according claim 27, further comprising:
a mercury removal step provided immediately before the sulfur compound conversion step.
